(19) United States
(12) Patent Application Publication
(10) Pub. No.: US 2024/0358132 A1
(43) Pub. Date: Oct. 31, 2024

(54) THERMAL INSULATION MEMBER FOR A HAIRCARE APPLIANCE

(71) Applicant: Dyson Technology Limited, Wiltshire (GB)

(72) Inventors: Kyle James CRAWFORD, Cirencester (GB); Samuel William SAUNDERS, Swindon (GB); Benjamin James HOGAN, Malmesbury (GB); Michael Medrano RECINTO, Lipa City (PH); Be Seng LOK, Singapore (SG); Ng Eric Purnama UTAMA, Singapore (SG); Craig DOUGLAS, Muntinlupa (PH)

(73) Assignee: Dyson Technology Limited, Wiltshire (GB)

(21) Appl. No.: 18/285,478

(22) PCT Filed: Apr. 1, 2022
(86) PCT No.: PCT/GB2022/050830

§ 371 Date: Oct. 3, 2023

(30) Foreign Application Priority Data
Apr. 8, 2021 (GB) 2104986.1

(51) Int. Cl. A45D 20/12

(52) U.S. Cl. CPC A45D 20/12

(57) ABSTRACT

A thermal insulation member is described for a heater assembly of a haircare appliance. The thermal insulation member is formed of an elastomeric material and includes a sleeve, a plurality of ribs, and a plurality of studs. The ribs and studs project outwardly from a surface of the sleeve, and the ribs project further the studs. A haircare appliance including the thermal insulation member is also described.

### FIELD OF THE INVENTION

The present invention relates to a thermal insulation member for a heater assembly of a haircare appliance.

### BACKGROUND OF THE INVENTION

Haircare appliances often use heat to treat or style hair. The temperatures involved can be relatively high, which then poses a potential risk to users of the appliances.

### SUMMARY OF THE INVENTION

The present invention provides a thermal insulation member for a heater assembly of a haircare appliance, the thermal insulation member being formed of an elastomeric material and comprising a sleeve, a plurality of ribs, and a plurality of studs, wherein the ribs and studs project outwardly from a surface of the sleeve, and the ribs project further than the studs.

The thermal insulation member is intended to surround the heater assembly to reduce the transfer of heat from the heater assembly to an outer body of the haircare appliance, which a user may contact. As a result, a potentially safer appliance may be achieved. Additionally, the efficiency of the haircare appliance may be improved by ensuring that more of the thermal energy generated by the heater assembly is transferred to the airflow moving through the heater assembly.

When the heater assembly and thermal insulation member are seated within the outer body, the ribs contact the outer body. As a result, the sleeve and the studs, which do not project as far as the ribs, are spaced from the outer body. Relatively good thermal insulation may therefore be achieved between the heater assembly and the outer body. The thermal insulation member is formed of an elastomeric material, which typically have a relatively low thermal conductivity. As a result, thermal transfer from the heater assembly to the outer body may be further reduced.

As noted, the studs are spaced from the outer body of the haircare appliance during normal use. Should the haircare appliance be dropped or otherwise subjected to an impact, the resulting acceleration of the heater assembly relative to the outer body may cause one or more of the studs to contact the outer body. On contacting the outer body, the studs deform so as to reduce the acceleration imparted to the heater assembly. As a result, damage to the heater assembly, which might otherwise occur if the studs were omitted, may be avoided. The thermal insulation member is therefore capable of providing relatively good thermal insulation whilst also protecting the heater assembly from impact damage.

The ribs may comprise circumferential ribs that extend about the sleeve in a circumferential direction, and longitudinal ribs that extend along the sleeve in a longitudinal direction. By providing ribs that extend both circumferentially (i.e. about the central, longitudinal axis of the sleeve) and longitudinally (i.e. parallel to the central, longitudinal axis of the sleeve), the sleeve may be spaced from the outer body using a relatively small number of ribs, thereby improving thermal insulation.

The ribs may comprise circumferential ribs that extend about the sleeve in a circumferential direction. Moreover, each of the circumferential ribs may subtend a central angle of between 15 and 45 degrees. That is to say that each of the ribs describes an arc about the sleeve that subtends a central angle (i.e. having an apex on the central longitudinal axis of the sleeve), of between 15 and 45 degrees. This then provides a relatively good balance between the need for ribs that are sufficiently long (i.e. subtend a large angle) to ensure that the sleeve is spaced from the outer body around the full circumference of the sleeve, and the need for ribs that are sufficiently short (i.e. subtend a small angle) to reduce thermal transfer.

The studs may be located between the ribs. As a result, relatively good impact protection may be provided by the studs. In particular, the ribs may space the sleeve from the outer body along the full length of the sleeve whilst the studs, being located between the ribs, may provide impact protection along the full length of the sleeve.

The studs may be dome-shaped. This then has the advantage that studs having a relatively low profile may be used. Moreover, when the outer body contacts the top of the stub in response to an impact, the stud is effectively squeezed and deforms laterally (i.e. in directions parallel to the surface of the sleeve). As a result, less of the impact is transferred to the heater assembly.

Two of the ribs may define a channel therebetween for receiving an electrical cable of the haircare appliance. The thermal insulation member therefore provides a useful secondary function, namely a cable guide. By locating the electrical cable between two ribs, the cable may be protected from potential damage in the event of an impact to the haircare appliance.

Two of the ribs may define a further channel therebetween for receiving a further electrical cable of the haircare appliance. The thermal insulation member is therefore capable of acting as a guide for multiple electrical cables. The channel and further channel may have different widths or may be located on opposite sides of the sleeve. The thermal insulation member is therefore capable of acting as a guide for electrical cables of different thickness or electrical cables requiring a different routing path along the haircare appliance.

The sleeve may comprise a circumferential strip devoid of ribs and studs, and the strip may be delimited on each side by ribs that extend about the sleeve in a circumferential direction. In particular, the strip may be delimited on one side by a first set of circumferential ribs and on an opposite side by a second set of circumferential ribs. The strip provides a space into which a band or the like of the haircare appliance may be received. Where the haircare appliance comprises an electrical cable that is routed along the length of the thermal insulation member, the band may be used to retain the electrical cable against the sleeve. By using circumferential ribs to delimit the sides of the strip, the ribs may help to locate the band or the like within the strip.

The thermal insulation member may comprise one or more annular lip seals located at an end of the sleeve. When the heater assembly and thermal insulation member are seated within the outer body, each of the lips seals forms an airtight seal against the outer body. As a result, airflow generated upstream of the heater assembly is prevented from bypassing the heater assembly (e.g. by flowing through the space between the thermal insulation member and the outer body). As a result, the performance of the haircare appliance may be improved.

The thermal insulation member may comprise one or more locating projections that projects inwardly from a surface of the sleeve. The locating projections are configured to engage with corresponding recesses in the heater assembly. This then has the advantage that, when the thermal insulation member, is slid onto and over the heater assembly, the locating projections engage with the recesses when the thermal insulation member is correctly positioned on the heater assembly. Furthermore, when the heater assembly and the thermal insulation member are inserted as a unit into the outer body, the locating projections help prevent movement of the thermal insulation member relative to the heater assembly during insertion.

The thermal insulation member may comprise one or more recesses or through-holes in the sleeve for receiving projections of a further assembly of the haircare appliance to secure the thermal insulation member to the further assembly. This then has the advantage that the thermal insulation member, the heater assembly and the further assembly must first be assembled as a single unit, which is then inserted into the outer body. Moreover, where the further assembly has electrical cables that need to be routed past the heater assembly, the further assembly may be secured to the thermal insulation member and the electrical cables may be routed within channels defined by the thermal insulation member.

The heater assembly may comprise a two-part housing, with the two halves of the housing being joined along the top and/or bottom of the housing. As a result, the outer profile of the heater assembly may be larger at the top and/or bottom of the heater assembly. Accordingly, the sleeve may be devoid of ribs and studs along at least one of the top or bottom of the sleeve. As a result, a relatively compact arrangement may be achieved.

The present invention also provides a haircare appliance comprising an outer body, a heater assembly and a thermal insulation member as described in any one of the preceding paragraphs, wherein the thermal insulation member surrounds the heater assembly, the outer body surrounds the thermal insulation member, the ribs contact the outer body, and the sleeve and studs are spaced from the outer body.

The haircare appliance may comprises a further assembly having one or more projections, the thermal insulation member comprises one or more recesses or through-holes in the sleeve, and the projections are received within the recesses or through-holes to secure the thermal insulation member to the further assembly.

As noted above, this then has the advantage that the thermal insulation member, the heater assembly and the further assembly must first be assembled as a single unit, and then inserted into the outer body. Moreover, where the further assembly comprises electrical cables that need to be routed past the heater assembly, the further assembly may be secured to the thermal insulation member and the electrical cables may be routed within channels defined by the thermal insulation member.

The haircare appliance may comprise an electrical cable and a band, the sleeve may comprise a circumferential strip devoid of ribs and studs, and the band may be received within the strip to retain the electrical cable. This then has the advantage that the electrical cable may be routed along the length of the thermal insulation member, and the band may be used to retain the electrical cable against the sleeve. The electrical cable may form part of the heater assembly. Alternatively, the electrical cable may form part of a further assembly of the haircare appliance. The haircare appliance may comprise a plurality of cables that are routed along the length of the thermal insulation member and are retained by the band. The electrical cables may be routed along different paths. For example, the electrical cables may be routed along opposite sides of the thermal insulation member. By providing a band that extends from one side to another of the sleeve, the same band may be used retain the electrical cables on both sides.

The heater assembly may comprise a housing having one or more recesses, and the thermal insulation member may comprise one or more locating projections that projects inwardly from a surface of the sleeve. The locating projections then engage with the recesses. As already noted, this then has the advantage that, when the thermal insulation member, is slid onto and over the heater assembly, the locating projections engage with recesses when the thermal insulation member is correctly positioned on the heater assembly. Furthermore, when the heater assembly and the thermal insulation member are inserted as a unit into the outer body, the locating projections help prevent movement of the thermal insulation member relative to the heater assembly during insertion.

The heater assembly may comprise one or more gaps through which an airflow passing through the heater assembly may escape. If unchecked, this heated air may heat the outer body. Accordingly, the thermal insulation member may provide an airtight seal around the heater assembly. As a result, the escape of heated air may be prevented. The temperature of the outer body may then be reduced and the efficiency of the haircare appliance may be improved.

### BRIEF DESCRIPTION OF THE DRAWINGS

Embodiments will now be described, by way of example, with reference to the accompanying drawings in which:

FIG. 1 is a simplified block diagram of a haircare appliance;

FIG. 2 is a perspective view of an assembly unit forming part of the haircare appliance;

FIG. 3 is an exploded view of the assembly unit of FIG. 2;

FIG. 4 is a first perspective view of a thermal insulation member forming part of the haircare appliance;

FIG. 5 is a second perspective view of the thermal insulation member; and

FIG. 6 is an exploded view of the ioniser assembly.

### DETAILED DESCRIPTION OF THE INVENTION

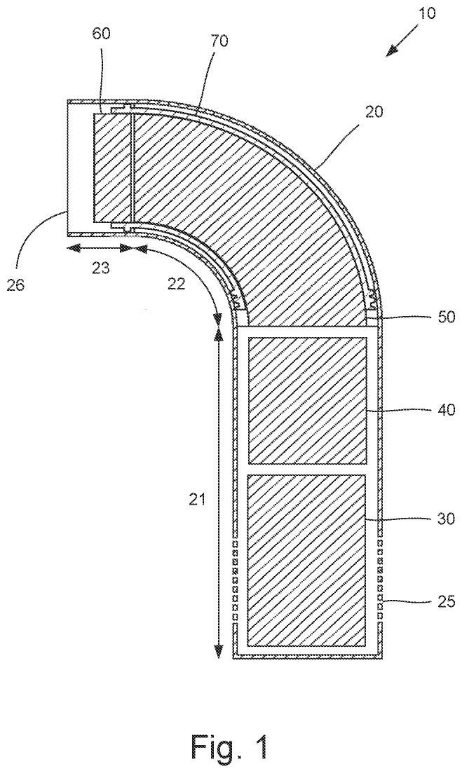

A haircare appliance 10 of FIG. 1 comprises an outer body 20 that houses a power and control unit 30, an airflow generator 40, a heater assembly 50, an ioniser assembly 60, and a thermal insulation member 70.

The outer body 20 is tubular in shape and comprises a handle portion 21, a curved portion 22, and an outlet portion 23. The handle portion 21 is generally straight and is intended to be gripped by a user during use of the haircare appliance 10. The handle portion 21 houses the power and control unit 30, and the airflow generator 40. The curved portion 22 extends between the handle portion 21 and the outlet portion 23, and turns through around 90 degrees. The curved portion 22 houses the heater assembly 50 and the thermal insulation member 70. The outlet portion 23 is generally straight and houses the ioniser assembly 60. A plurality of perforations are formed around the lower part of the handle portion and serve as an air inlet 25 of the haircare appliance 10, and an open end of the outlet portion 23 serves as an air outlet 26.

The power and control unit 30 comprises power electronics and control circuitry for powering and controlling the operation of the airflow generator 40, the heater assembly 50, and the ioniser assembly 60. For example, the power and control unit 30 may comprise user controls for powering on and off the haircare appliance 10, and for adjusting the flow and temperature settings. In response to the changes in the user controls, the power and control unit 30 may control the speed of the airflow generator 40 in order to adjust the flow rate, and/or the electrical power drawn by the heater assembly 50 in order to adjust the temperature. In this particular example, the power and control unit 30 is located within the outer body 20. Alternatively, the power and control unit 30 may be located, in part or in whole, outside of the main body 20. For example, the power and control unit 30 may form part of a power brick, adapter or the like.

The airflow generator 40 generates an airflow that moves through the haircare appliance 10 from the inlet 25 to the outlet 26. More particularly, the airflow generator 40 draws air into the haircare appliance 10 via the air inlet 25. The air then moves through the airflow generator 40, the heater assembly 50 and the ioniser assembly 60 before being expelled from the haircare appliance 10 via the outlet 26. The airflow generator 40 may comprise an impeller driven by an electric motor, such as the Dyson digital motor V9 used in the Dyson Supersonic® hair dryer.

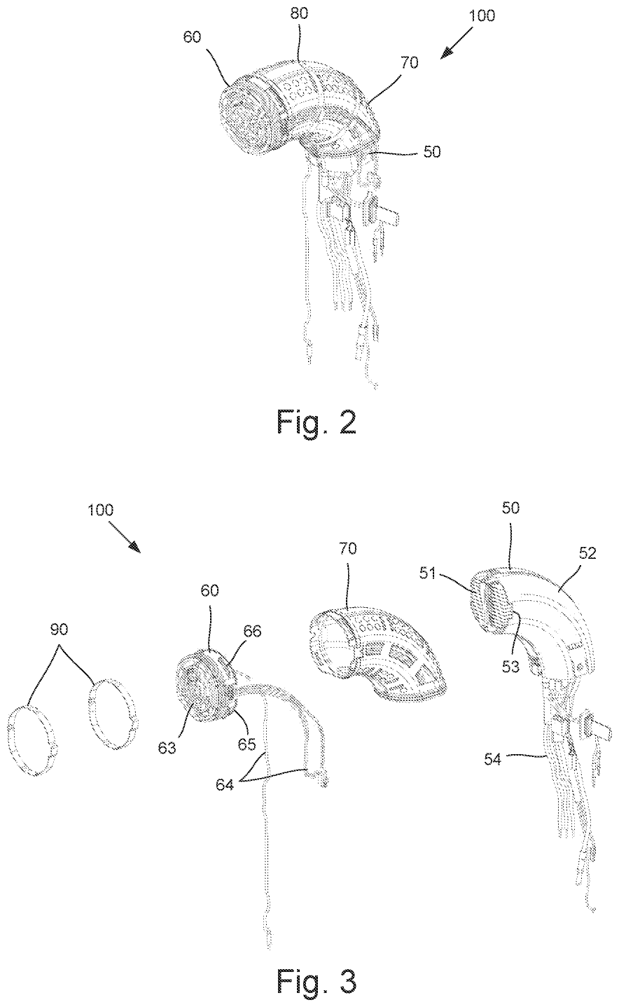

As shown in FIGS. 2 and 3, the heater assembly 50, the ioniser assembly 60 and the thermal insulation member 70, together with a pair of retaining bands 90, collectively form an assembly unit 100.

The heater assembly 50 comprises an electric heater 51 housed within a housing 52. When powered by the power and control unit 30, the electric heater 51 heats the airflow moving through the heater assembly 50. The heater assembly 50 extends along the length of the curved portion 22 of the outer body 20 and, like the curved portion 22, is curved and turns through roughly 90 degrees.

The ioniser assembly 60 comprises an ioniser, a thermistor, and a grill 63. The ioniser and thermistor are obscured by the grill 63 and cannot be easily seen in the Figures. When powered by the power and control unit 30, the ioniser 60 ionises the airflow expelled from the haircare appliance 10. The thermistor is used by the power and control unit 30 to sense the temperature of the airflow, and the grill 63 is used to protect a user from inadvertently contacting the heater assembly 50.

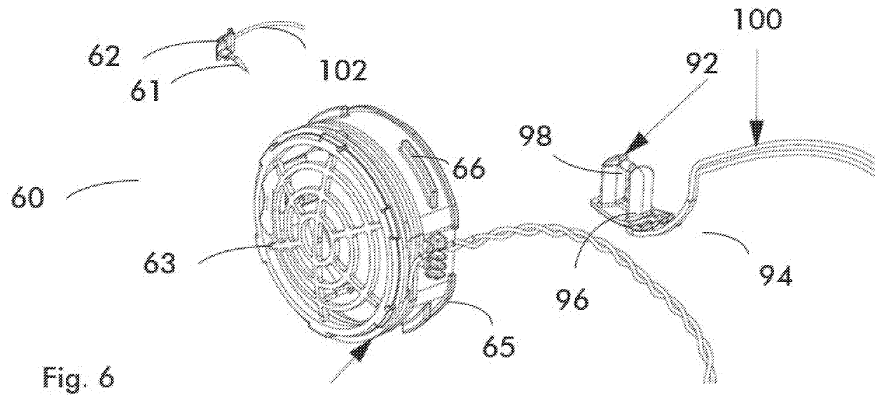

FIG. 6 shows an exploded view of the ioniser assembly 60. An ionising needle 61 is connected via a wire 102 to an ioniser (not shown). A housing 62 is overmoulded over the connection between the wire 102 and the ionising needle 61.

This serves two purposes, it protects this connection point and it provides a supporting structure for the ionising needle 61 which can engage with the ioniser assembly 60 retaining it in place. In addition, the housing 62 seals against air flowing between the ioniser assembly 60 and the outer wall 20 of the appliance 10.

In a similar manner, the thermistor 92 is retained with respect to a housing 94. The housing 94 has a base 96 and two arms 98 that extend from the base 96. The thermistor 92 is supported at each end by one of the two arms 98. Electrical wiring 100 connects the thermistor to a heater control circuit (not shown) is routed through the two arms 98 and out of the base 96 to a connector (not shown) which connects to the power and control unit 30.

In order that the thermistor 92 is reliably positioned with respect to the ioniser assembly 60, the housing 94 forms part of the ioniser assembly 60. The housing 94 and ioniser assembly 60 are provided with cooperating features (not shown) that indicate when the correct position is reached. In addition, the housing 94 seals against air flowing between the ioniser assembly 60 and the outer wall 20 of the appliance 10.

The thermal insulation member 70, which is described below in more detail, surrounds the heater assembly 50, and is used to insulate the heater assembly 50 from the outer body 20 of the haircare appliance 10. The thermal insulation member 70 also includes features for securing the ioniser assembly 60 to an end of the thermal insulation member 70.

The heater assembly 50 and the ioniser assembly 60 each comprises electrical cables 54,64 that are connected to the power and control unit 30. The electrical cables 64 of the ioniser assembly 60 are routed along the outside of the thermal insulation member 70. The retaining bands 90 surrounds the thermal insulation member 70 and the electrical cables 64 and act to retain the electrical cables 64 against the thermal insulation member 70.

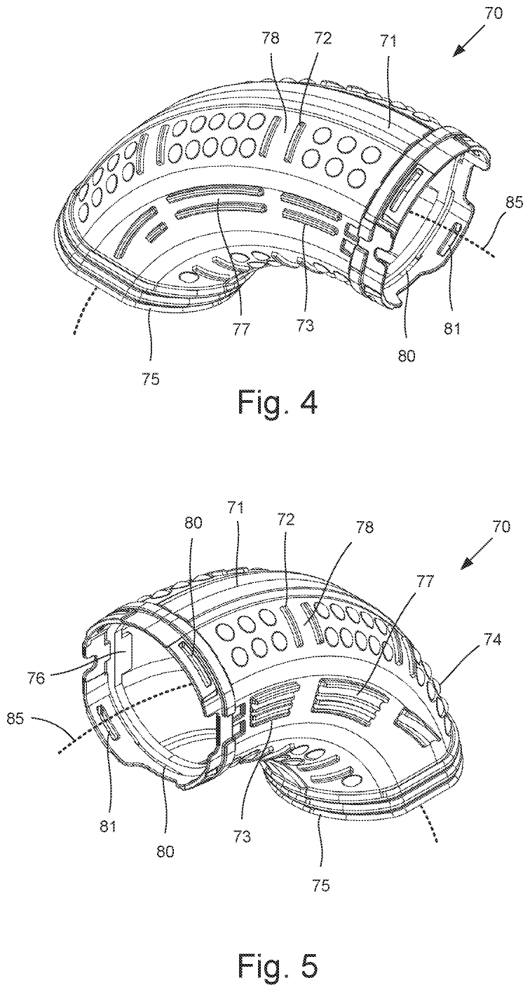

Referring now to FIGS. 4 and 5, the thermal insulation member 70 is a unitary, single-piece component formed of an elastomeric material have a relatively low thermal conductivity, such as silicone or EPDM.

The thermal insulation member 70 comprises a sleeve 71, a plurality of ribs 72,73, a plurality of studs 74, a plurality of lips seals 75, and a pair of locating features 76.

The sleeve 71 is tubular, curved and corresponds in shape to the outer surface of the heater assembly 50. The inner dimensions (e.g. the inner diameter) of the sleeve 71 are slightly smaller than the outer dimensions (e.g. the outer diameter) of the heater assembly 50. Consequently, when the thermal insulation member 70 is placed over the heater assembly 50, the sleeve 71 is pulled tight against the heater assembly 50, the benefits of which are described below. The sleeve 71 is shorter than the heater assembly 50, as can be seen in FIG. 3. Again, the reasons for this are explained below.

Each of the ribs 72,73 comprises a narrow projection that projects outwardly from the outer surface of the sleeve 71. In comprising a narrow projection, the length of each rib 72,73 is significantly larger than the width of the rib 72,73. For example, the length of each rib 72,73 may be at least three times the width.

The ribs 72,73 comprise circumferential ribs 72 and longitudinal ribs 73. The circumferential ribs 72 extend about the sleeve 71 in a circumferential direction, whilst the longitudinal ribs 73 extend along the sleeve 71 in a longitudinal direction. The directions ‘circumferential’ and ‘longitudinal’ are defined with reference to the central, longitudinal axis 85 of the sleeve 70. Consequently, the circumferential ribs 72 extend in directions about the longitudinal axis 85 of the sleeve 71, and the longitudinal ribs 73 extend in directions parallel to the longitudinal axis 85.

The circumferential ribs 72 do not extend fully around the sleeve 71. Instead, each circumferential rib 72 subtends a central angle of about 25 degrees. That is to say that each of the circumferential ribs 72 describes an arc about the sleeve 71 that subtends a central angle, having an apex on the central longitudinal axis 85 of the sleeve 71, of about 25 degrees.

Likewise, the longitudinal ribs 73 do not extend fully along the length of the sleeve 71. The longitudinal ribs 73 are located on the left and right sides of the sleeve 71. Pairs of longitudinal ribs 73 define channels 77 therebetween for receiving the electrical cables 64 of the ioniser assembly 60. In this particular example, a single channel is provided on the left side of the sleeve 71, and three channels are provided on the right side of the sleeve 71. Moreover, the channels are of different widths to accommodate electrical cables 64 of different sizes.

Each of the studs 74 comprises a dome-shaped projection that projects outwardly from the outer surface of the sleeve 71. The studs 74 are located between the ribs 72,73 but do not project as far as the ribs 72,73, i.e. the studs 74 are shorter than the ribs 72,73.

The lip seals 75 are located at an end of the sleeve 71. More particularly, the lip seals 75 are provided at an upstream end of the sleeve 71, i.e. that end of the sleeve 71 proximal the airflow generator 40. Each of the lip seals 75 comprises an annular projection that projects outwardly from and surrounds the sleeve 71. In this particular example, the thermal insulation member 70 comprises three lip seals 75.

The locating projections 76 project inwardly from the inner surface of the sleeve 71. The locating projections 76 and located on the left and right sides of the sleeve 71 towards an end of the sleeve 71. More particularly, the locating projections 76 are located towards the downstream end of the sleeve 71, i.e. that end distal the airflow generator 40. The locating projections 76 are rectangular in shape and are intended to engage with corresponding recesses 53 in the heater assembly 50.

The sleeve 71 comprises a pair of circumferential strips 78 that are devoid of ribs 72,73 and studs 74. The strips 78 are used to receive the retaining bands 90 shown in FIGS. 2 and 3. The strips 78 are delimited on each side by circumferential ribs 72. In particular, each strip 78 is delimited on one side by a first set of circumferential ribs 72 and on an opposite side by a second set of circumferential ribs 72. By using the circumferential ribs 72 to delimit the strips 78, the ribs 72 help to locate and seat the retaining bands 90 within the strips 78 during assembly.

The thermal insulation member 70 also comprises features 80,81 for securing the ioniser assembly 60 to the thermal insulation member 70. The features are provided at an end of the sleeve 71 and comprises a pair of recesses or grooves 80, and a plurality of through-holes 81. The recesses 80 are formed in the inner surface of the sleeve 71, with one of the recesses located in the top portion of the sleeve 71 and the other of the recesses located in the bottom portion of the sleeve 71. Each of the through-holes 81 takes the form of a narrow slot that extends through the sleeve 71. In this particular example, there are four through-holes 81 spaced evenly about the end of the sleeve 71. As can be seen in FIG. 3, the ioniser assembly 60 comprises a plurality of projections 65,66 that engage with the features 80,81 in the sleeve 71. In particular, the ioniser assembly 60 comprises a pair of flanges 65 that sit within the recesses 80 in the sleeve 71, and a plurality of tabs 66, each of which projects through a respective through-hole 81 in the sleeve 71.

During assembly, the thermal insulation member 70 is stretched over and pulled onto the heater assembly 50. The thermal insulation member 70 is pulled onto the heater assembly 50 until the locating projections 76 are seated within the corresponding recesses 53 in the housing 52 of the heater assembly 50. The ioniser assembly 60 is then inserted into the free end of the sleeve 71 of the thermal insulation member 70, with the flanges 65 and tabs 66 of the ioniser assembly 60 engaging with the recesses 80 and through-holes 81 of the thermal insulation member 70. The electrical cables 64 of the ioniser assembly 60 are then routed along opposite sides of the thermal insulation member 70. The electrical cables 64 are seated within the channels 77 defined by the longitudinal ribs 73 of the thermal insulation member 70. The retaining bands 90 are then inserted over the thermal insulation member 70 and seated within the strips 78 delimited by the circumferential ribs 72. Finally, the retaining bands 90 are crimped or squashed, causing the retaining bands 90 to deform to retain the electrical cables 64 against the thermal insulation member 70. FIG. 2 illustrates the resulting assembly unit 100 prior to crimping the retaining bands 90.

The assembly unit 100 is then inserted into the curved portion 22 of the outer body 20. The assembly unit 100 is inserted such that the ioniser assembly 60 leads.

The thermal insulation member 70 is sized such that, when the assembly unit 100 is fully inserted into the outer body 20, the ribs 72,73 and the lip seals 75 only of the thermal insulation member 70 contact the outer body 20. Consequently, during insertion of the assembly unit 100 into the curved portion 22, friction arises between the ribs, the lip seals and the inner surface of outer body 20. As noted above, the sleeve 71 of the thermal insulation member 70 is pulled tight against the heater assembly 50. Additionally, the locating projections 76 of the thermal insulation member 70 engage with recesses 53 in the housing 52 of the heater assembly 50. Consequently, in spite of the friction that arises between the thermal insulation member 70 and outer body 20 during insertion, movement of the thermal insulation member 70 relative to the heater assembly 50 is prevented.

When the assembly unit 100 is seated within the outer body 20, the ribs 72,73 and the lip seals 75 of the thermal insulation member 70 contact the outer body 20. The sleeve 71 and the studs 74, which do not project as far as the ribs 72,73, are therefore spaced from the outer body 20. As a result, good thermal insulation is achieved between the heater assembly 50 and the outer body 20.

The lips seals 75 create a seal between the heater assembly 50 and the outer body 20. This ensures that more of the airflow generated by the airflow generator 40 passes through and does not circumvent the heater assembly 50, thereby improving the performance of the haircare appliance 10. It can be seen in FIG. 3 that, owing to the electrical cables 64 of the ioniser assembly 60, the seal provided by the lip seals 75 is not perfect. However, it is not essential that the seal is perfect. Indeed, an imperfect seal may be beneficial by allowing a small amount of the airflow, which is relatively cool, to pass between the sleeve 71 and the outer body 20.

The housing 52 of the heater assembly 50 comprises holes, gaps and other leakage paths through which air heated by the electric heater 51 may escape. The sleeve 71 of the thermal insulation member 70, however, is pulled tight and forms a seal against the housing 52. As a result, heated air is prevented from escaping the housing 52 into the space between the heater assembly 50 and the curved portion 22 of the outer body 20, thus improving the thermal insulation.

The studs 74 of the thermal insulation member 70 protect the heater assembly 50 from potential damage in the event that the haircare appliance 10 is dropped or otherwise subjected to an impact. The ribs 72,73 of the thermal insulation member 70 contact the outer body 20 over a relatively small total contact area. This then has the benefit of providing relatively good thermal insulation. However, should the haircare appliance 10 be dropped or otherwise subjected to an impact, the resulting acceleration of the heater assembly 50 relative to the outer body 20 could, in the absence of the studs 74, cause the sleeve 71 to impact the outer body 20. The impact would then be transferred directly to the heater assembly 50 and may damage the electric heater 51. The studs 74 of the thermal insulation member 70 are spaced from the outer body 20 during normal use. As a result, good thermal insulation continues to be provided. However, should the haircare appliance 10 be subjected to an impact, one or more of the studs 74 (rather than the sleeve 71) contact the outer body 20. On contacting the outer body 20, the studs 74 deform so as to absorb and reduce the impact that is imparted to the heater assembly 50. As a result, damage to the heater assembly 50, which might otherwise occur if the studs 74 were omitted, may be avoided. The thermal insulation member 70 therefore provides good thermal insulation whilst also protecting the heater assembly 50 from impact damage.

The studs 74 are dome-shaped, which has at least two benefits. First, the studs have a relatively low profile and thus a relatively compact arrangement may be achieved. Second, when the outer body 20 contacts the top of a stub 74 in response to an impact, the stud 74 deforms laterally (i.e. in directions parallel to the surface of the sleeve 71). As a result, less of the impact is transferred to the heater assembly 50. Nevertheless, in spite of these advantages, alternatively-shaped studs 74 could conceivably be used.

The thermal insulation member 70 comprises both circumferential ribs 72 and longitudinal ribs 73. Conceivably, the sleeve 71 may be spaced from the outer body 20 using just circumferential ribs 72 or just longitudinal ribs 73, or indeed ribs that extend in a different direction altogether. However, by employing a combination of circumferential ribs 72 and longitudinal ribs 73, a spacing may be achieved around and along the entirety of the sleeve 71 using ribs have a relatively small total contact area, thereby improving thermal insulation.

In the particular example described above, each of the circumferential ribs 72 subtends a central angle of about 25 degrees. This then provides a relatively good balance between the need for ribs that are sufficiently long (i.e. subtend a large angle) to ensure that the sleeve 71 is spaced from the outer body 20 around the full circumference of the sleeve 71, and the need for ribs that are sufficiently short (i.e. subtend a small angle) to minimise the contact area and thus reduce thermal transfer. Whilst circumferential ribs 72 having a smaller or larger central angle may be used, it should be possible to maintain a relatively good balance between these two competing needs by employing ribs 72 that subtend a central angle of between 15 and 45 degrees.

The longitudinal ribs 73 do not extend along the full length of the sleeve 71 but are instead broken into smaller length ribs. This again helps to reduce the total contact area and thus improve thermal insulation. The longitudinal ribs 73 are used define to channels 77 therebetween for receiving electrical cables of the haircare appliance 10. In the example described above, the haircare appliance 10 comprises an ioniser assembly 60 and the longitudinal ribs 73 are used to route electrical cables 64 of the ioniser assembly 60. However, the ribs 73 might additionally or alternatively be used to route electrical cables that form part of the heater assembly or some other electrical assembly of the haircare appliance 10.

The thermal insulation member 70 comprises two strips 78 that are devoid of ribs 72,73 and studs 74. Each strip 78 provides a space for one of the retaining bands 90. In the example described above, each of the strips 78 is annular and extends fully around the sleeve 71. Conceivably, the strips 78 may extend around only a part of the sleeve 71 and the retaining bands 90, rather than being annular, may be c-shaped.

The top and bottom of the thermal insulation member 70 are also devoid of ribs 72,73 and studs 74. This is because the housing 52 of the heater assembly 50 is formed in two parts, which are joined together along the top and bottom of the heater assembly 50. As a result, the heater assembly 50 is raised along the top and bottom of the heater assembly 50. The thermal insulation member 70 is therefore devoid of ribs 72,73 and studs 74 along the top and bottom of the sleeve 71 such that the outer profile of the thermal insulation member 70 matches that of the inner surface of the curved portion 22 of the outer body 20.

The locating projections 76 of the thermal insulation member 70 provide two useful benefits. First, when the thermal insulation member 70, is slid onto and over the heater assembly 50, the locating projections 76 engage with corresponding recesses 53 in the heater assembly 50. The locating projections 76 therefore ensure that the thermal insulation member 70 is correctly positioned on the heater assembly 50. Second, when the heater assembly 50 and the thermal insulation member 70 are inserted as a unit 100 into the outer body 20, the locating projections 76 help prevent movement of the thermal insulation member 70 relative to the heater assembly 50. Whilst the locating projections 76 are located towards an end of the sleeve 71, and the recesses 53 are located in an end of the housing 52, the projections 76 and recesses 53 may be located elsewhere.

As can be seen in FIG. 2, the thermal insulation member 70 is shorter than the heater assembly 50. As a result, an end of the housing 52 of the heater assembly 50 extends beyond the thermal insulation member 70. This is done such that the housing 52 may be screwed to the outer body 20 to better secure the assembly unit 100 to the outer body 20. Although a portion of the housing 52 is now exposed, it is the upstream end of the housing 52 that is exposed. The temperature of the air at the exposed end of the housing 52 has not therefore been heated and is relatively cool. Consequently, although the thermal insulation member 70 does not fully cover the heater assembly 50, relatively good thermal insulation is nevertheless achieved.

Whilst particular examples and embodiments have been described, it should be understood that various modifications may be made without departing from the scope of the invention as defined by the claims. For example, whilst the lips seals 75, the locating projections 76, the channels 77, the strips 78, the recesses 80 and the through-holes 81 of the thermal insulation member 70 each have their benefits, they are not critical in providing thermal insulation. As a further example, the heater assembly 50 and the thermal insulation sleeve 70, in the example described above, are curved and are housed within a curved portion 22 of the haircare appliance 10. However, the heater assembly 50 and the thermal insulation member 70 might equally be straight and may be housed within a straight portion of the haircare application 10.

1. A thermal insulation member for a heater assembly of a haircare appliance, the thermal insulation member being formed of an elastomeric material and comprising a sleeve, a plurality of ribs, and a plurality of studs, wherein the ribs and studs project outwardly from a surface of the sleeve, and the ribs project further than the studs.

2. The thermal insulation member as claimed in claim 1, wherein the ribs comprise circumferential ribs that extend about the sleeve in a circumferential direction, and longitudinal ribs that extend along the sleeve in a longitudinal direction.

3. The thermal insulation member as claimed in claim 1, wherein the ribs comprise circumferential ribs that extend about the sleeve in a circumferential direction, and each of the circumferential ribs subtends a central angle of between 15 and 45 degrees.

4. The thermal insulation member as claimed in claim 1, wherein the studs are located between the ribs.

5. The thermal insulation member as claimed in claim 1, wherein the studs are dome-shaped.

6. The thermal insulation member as claimed in claim 1, wherein two of the ribs define a channel therebetween for receiving an electrical cable of the haircare appliance.

7. The thermal insulation member as claimed in claim 6, wherein two of the ribs define a further channel therebetween for receiving a further electrical cable of the haircare appliance.

8. The thermal insulation member as claimed in claim 7, wherein the channel and further channel have different widths or are located on opposite sides of the sleeve.

9. The thermal insulation member as claimed in claim 1, wherein the sleeve comprises a circumferential strip devoid of ribs and studs, and the strip is delimited on each side by ribs that extend about the sleeve in a circumferential direction.

10. The thermal insulation member as claimed in claim 1, wherein the thermal insulation member comprises one or more annular lip seals located at an end of the sleeve.

11. The thermal insulation member as claimed in claim 1, wherein the thermal insulation member comprises one or more locating projections that project inwardly from a surface of the sleeve, the locating projections configured to mate with corresponding recesses in the heater assembly.

12. The thermal insulation member as claimed in claim 1, wherein the thermal insulation member comprises one or more recesses or through-holes in the sleeve for receiving projections of a further assembly of the haircare appliance to secure the thermal insulation member to the further assembly.

13. The thermal insulation member as claimed in claim 1, wherein the sleeve is devoid of ribs and studs along at least one of the top and bottom of the sleeve.

14. The haircare appliance comprising an outer body, a heater assembly and a thermal insulation member as claimed in claim 1, wherein the thermal insulation member surrounds the heater assembly, the outer body surrounds the thermal insulation member, the ribs contact the outer body, and the sleeve and studs are spaced from the outer body.

15. The haircare appliance as claimed in claim 14, wherein the haircare appliance comprises a further assembly having one or more projections, the thermal insulation member comprises one or more recesses or through-holes in the sleeve, and the projections are received within the recesses or through-holes to secure the thermal insulation member to the further assembly.

16. The haircare appliance as claimed in claim 14, wherein the haircare appliance comprises an electrical cable, two of the ribs define a channel therebetween, and the electrical cable is received within and extends along the channel.

17. The haircare appliance as claimed in claim 14, wherein the haircare appliance comprises an electrical cable and a band, the sleeve comprises a circumferential strip devoid of ribs and studs, and the band is received within the strip to retain the electrical cable.

18. The haircare appliance as claimed in claim 14, wherein the heater assembly comprises a housing having one or more recesses, the thermal insulation member comprises one or more locating projections that project inwardly from a surface of the sleeve, and the locating projections mate with the recesses.

19. The haircare appliance as claimed in claim 14, wherein the thermal insulation member provides an airtight seal around the heater assembly.
